(19) United States
(12) Patent Application Publication
(10) Pub. No.: US 2017/0177206 A1
(43) Pub. Date: Jun. 22, 2017

(54) METHOD FOR INTERACTION WITH TERMINAL AND ELECTRONIC APPARATUS FOR THE SAME

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Rui WANG, Beijing (CN)

(73) Assignees: LE HOLDINGS (BEIJING) CO., LTD., Beijing (CN); LE SHI ZHI XIN ELECTRONIC TECHNOLOGY (TIANJIN) LIMITED, Beijing (CN)

(21) Appl. No.: 15/247,809

(22) Filed: Aug. 25, 2016

Related U.S. Application Data
(63) Continuation of application No. PCT/CN2016/088718, filed on Jul. 5, 2016.

(30) Foreign Application Priority Data
Dec. 18, 2015 (CN) 201510960784.7

(51) Int. Cl. G06F 3/0488; G06F 3/16

(52) U.S. Cl. CPC G06F 3/04883; G06F 3/167

(57) ABSTRACT

The present application discloses a method for interaction with terminal and an electronic apparatus for the same. The method includes: determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished; determining an operation type corresponding to the gesture, according to determination of whether the downward acceleration of the gesture is greater than the default threshold value; and executing an interaction corresponding to the operation type, according to the operation type.

### CROSS REFERENCE TO RELATED APPLICATIONS

This application is a continuation of International Application No. PCT/CN2016/088718, filed on Jul. 5, 2016, which is based upon and claims priority to Chinese Patent Application No. 201510960784.7, filed on Dec. 18, 2015, the entire contents of which are incorporated herein by reference.

### TECHNICAL FIELD

The present disclosure relates to a field of interactive process for information, particular to a method for interaction with terminal and an electronic apparatus for the same.

### BACKGROUND

With the improvement of vehicle technology, speech recognition function has been integrated in the vehicle to be a critical configuration. The speech recognition function in the vehicle provides convenience while reduces danger of car drive, and mobile terminal including speech recognition function, such as speech assistant, has become more popularized. However, among current mobile application market, the main function in the intelligent speech recognition product is to accumulate information, and the user usually interacts with the mobile terminal by talking. This user interface cannot properly applicable to vehicle technology since a demand for obtaining the information is more harshly required by the user who is driving car. Excessive information and overly complex operation steps will increase the user operation cost so as to influence the normal of car drive.

Inventor finds that the conventional speech assistant is usually changed between a recording state and an idle state by a user to click a button. There are too many characters and operations executed after the recognition of word meaning. Thus, it spends overly high user operation cost to execute extremely complex steps for changing the current interface back to the recording interface from the speech recognition interface or the word meaning execution interface.

In order to simplify the steps for changing the current interface back to the recording interface and to solve other disadvantages in the conventional technique, a new method for interaction with terminal should be developed.

### SUMMARY

The application provides a method for interaction with terminal and a device for the same. The method and the device are for solving the problems in the conventional technique that the user operation cost is increased when the current interface is changed to the purpose interface through overly complex interactive interfaces.

To solve the problems in the conventional technique, the application discloses a method for interaction with terminal, including:

Determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished;

Determining an operation type corresponding to the gesture, according to determination of whether the downward acceleration of the gesture is greater than the default threshold value; and

Executing an interaction corresponding to the operation type, according to the operation type.

To solve the problems in the conventional technique, the application also discloses a non-volatile computer storage medium storing a computer-executable instruction, and the computer-executable instruction is adapted for executing the method for interaction with terminal in any one of the embodiments.

The application also discloses an electronic apparatus, including: at least one processor and a memory communicatively connected to the at least one processor. The memory stores an instruction executable by the at least one processor, and the at least one processor is adapted for calling the instruction to execute the method for interaction with terminal in any one of the embodiments.

Compared to the conventional technique, the application can achieve the following technical effect:

The method and the device are favorable for solving the problems in the conventional technique that the user operation cost is increased when the current interface is changed to the recording interface. Specifically, the displayed interface can be directly returned to the speech recognition interface by simply operation with the user's gesture, and the operation steps is also reduced and become convenient. Since the steps for changing the interface back to the recording interface are simplified, it is favorable for reducing user operation cost so as to improve user experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technique flow chart of an embodiment of the present application;

FIG. 2 is a schematic view of a device of another embodiment of the present application; and

FIG. 3 is a schematic view of an electronic apparatus of another embodiment of the present application.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings. The embodiments enable others skilled in the art to best utilize the disclosure and various embodiments with various modifications as are suited to the particular use contemplated. The embodiments and the appended drawings are exemplary and are not intended to be exhaustive or to limit the scope of the disclosure to the precise forms disclosed. Modifications and variations are possible in view of the following teachings.

In the conventional technique, the speech assistant product is generally switched to be at either the record state or the idle state by a user to click a button, and there are too many characters and operations executed after the recognition of word meaning. The operation cost is increased due to excessive useless information and overly complex interactive interfaces. For a user who is driving car, it spends overly high user operation cost to execute extremely complex steps for changing the current interface back to the recording interface from the speech recognition interface or word meaning execution interface, and thereby the car drive is influenced. A demand for obtaining the information is harshly required by the user who is driving car. If the steps for changing the current interface back to the recording interface can be simplified, it is favorable for reducing user operation cost so as to improve user experience. To clarify the purpose of the present disclosure, the technical features and the advantages, detail description are disclosed hereafter by specific embodiments together with corresponding drawings.

### 1^{st} Embodiment

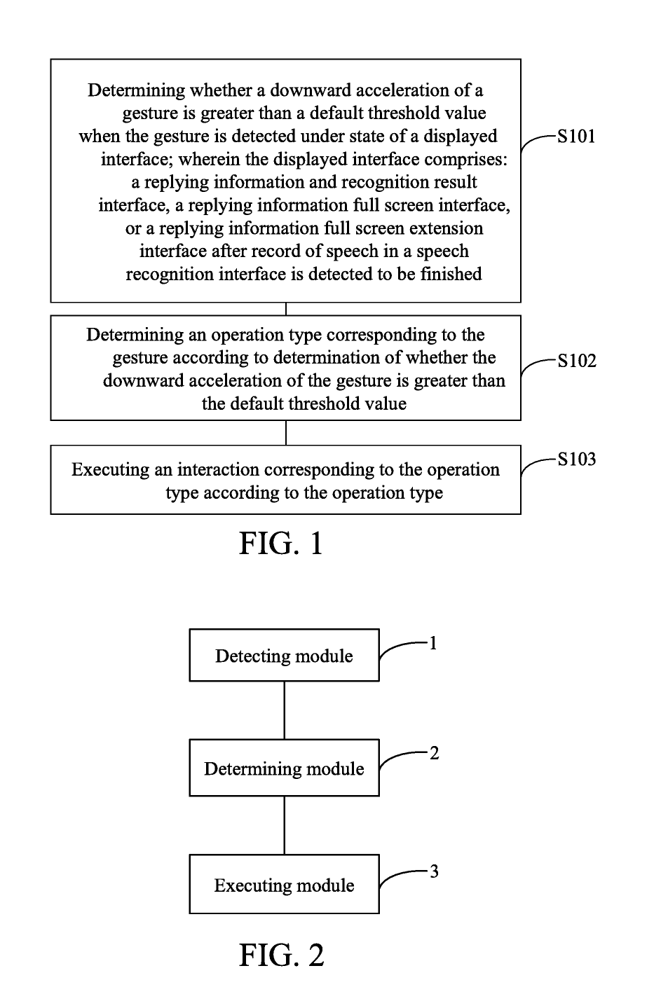

FIG. 1 is a technique flow chart of an embodiment of the present application. As shown in FIG. 1:

The embodiment of the present disclosure provides a method for interaction with terminal, and the method includes:

Step S101: determining whether a downward acceleration of a gesture is greater than a default threshold value when the gesture is detected under a state of a displayed interface, wherein the displayed interface comprises: a replying information and recognition result interface, a replying information full screen interface, or a replying information full screen extension interface after record of speech in a speech recognition interface is detected to be finished;

The user interacts with the interfaces via a client of a mobile terminal. The state of the displayed interface can be, for example, an interface displayed by the speech assistant after the car driver interacts with the speech assistant so record the speech in the speech recognition interface. The displayed interface includes: a replying information and recognition result interface, a replying information full screen interface, or a replying information full screen extension interface. The replying information and recognition result interface is an interface on which some replying information generated according to the content of speech and some recognition result generated according to the content of speech are both displayed. The replying information full screen interface is an interface on which the replying information is displayed while the recognition result is hidden. The replying information full screen extension interface is an interface on which a part of the replying information is displayed, and the user is able to slide the screen to move the interface downward to read the rest of the replying information.

Under the aforementioned displayed interface, the downward acceleration of the gesture is determined to be greater than the default threshold value or not after the gesture is detected. The purpose of determining whether the downward acceleration is greater than the default threshold value is to determine an operation type of the gesture. With the default threshold value as a determination standard, the operation type is determined to be a normal type or an accelerated type.

Step S102: determining the operation type corresponding to the gesture, according to the determination of whether the downward acceleration of the gesture is greater than the default threshold value.

By the result of the determination in the step S101, the operation type corresponding to the gesture is determined. Preferably, in this embodiment of the present disclosure, a step can be executed before determining the operation type, and the step is: presetting a matching relationship between the gesture and the operation type; and determining the operation type corresponding to the gesture according to determination of whether the downward acceleration of the gesture is greater than the default threshold value combined with the matching relationship between the gesture and the operation type.

Step S103: executing an interaction corresponding to the operation type, according to the operation type.

After the operation type is determined by the step S102, the interaction corresponding to the operation type is executed according to the operation type. The interaction includes, but not limited to, a progressive change from the replying information full screen extension interface to the replying information full screen interface, or alternatively, a progressive change from the replying information full screen interface to the replying information and recognition result interface, or alternatively, a progressive change from the replying information and recognition result interface to the speech recognition interface, and so on.

Preferably, in this embodiment of the present disclosure, the step S102 can include:

Determining the operation type corresponding to the gesture to be a normal type, if the downward acceleration of the gesture is not greater than the default threshold value, wherein the normal type comprises: a normally sliding type and a clicking type; and determining the operation type corresponding to the gesture to be an accelerated type, if the downward acceleration of the gesture is greater than the default threshold value.

When the downward acceleration of the gesture is determined to be not greater than the default threshold value, the operation type is determined to be the normal type; that is, there is no accelerated sliding effect between the user and the interfaces during the interaction, such that the relative displacement among the interfaces is smaller. When the operation type is the normally sliding type, the interaction is executed according to a default interaction strategy, such that the corresponding interfaces is progressively displayed with the gesture according to an interfaces connection strategy. When the downward acceleration of the gesture is not greater than the default threshold value, there is an additional situation that the operation type is determined to be the clicking type; that is, the downward acceleration of the clicking gesture is not greater than the default threshold value, and such operation type of the gesture also belongs to the normal type.

When the downward acceleration of the gesture is greater than the default threshold value, the operation type corresponding to the gesture to is determined to be the accelerated type; that is, there is an accelerated sliding effect between the user and the interfaces during the interaction, such that the relative displacement among the interfaces is larger. When the operation type is the accelerated type, the interface is directly changed back to the speech recognition interface with the gesture.

Preferably, in this embodiment of the present disclosure, the step S103 can include: executing the interaction according to the default interaction strategy when the operation type is the normally sliding type, wherein the default interaction strategy comprises: the displayed interface is progressively changed from the replying information full screen extension interface to the replying information full screen interface with the gesture, or alternatively, the displayed interface is changed from the replying information full screen interface to the replying information and recognition result interface with the gesture, or alternatively, the displayed interface is changed from the replying information and recognition result interface to the speech recognition interface with the gesture; triggering a button located on the top edge of the displayed interface such that current interface is directly changed back to the speech recognition interface when the operation type is the clicking type under the replying information full screen extension interface or the replying information full screen interface; and changing current interface back to the speech recognition interface directly when the operation type is the accelerated type.

When the downward acceleration of the gesture is determined to be not greater than the default threshold value, the operation type is determined to be the normal type. The user slides the gesture from the top of the interface to the bottom thereof. When the interface is the replying information full screen extension interface, it is progressively changed to the replying information full screen interface with the gesture; or, when the interface is the replying information full screen interface, it is progressively changed to the replying information and recognition result interface with the gesture; or, when the interface is the replying information interface, it is progressively changed to the speech recognition interface.

When the operation type is determined to be the clicking type under the replying information full screen extension interface or the replying information full screen interface, a button located on the top edge of the interface can be triggered such that the current interface can be directly changed back to the speech recognition interface.

When the operation type is determined to be the accelerated type, the interface is directly changed back to the speech recognition interface.

By simply operation, the interface includes no excessive useless information, and can be directly changed back to the speech recognition interface instead of through overly complex interactive interfaces. Therefore, it is favorable for improving the convenience of operation and preventing complex operation steps so as to reduce the user operation cost.

### 2^{nd} Embodiment

FIG. 2 is a schematic view of a device of another embodiment of the present application. As shown in FIG. 2:

The embodiment of the present disclosure provides a device for interaction with terminal, and the device includes:

A detecting module 1 adapted for determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished;

A determining module 2 adapted for determining an operation type corresponding to the gesture according to determination of whether the downward acceleration of the gesture is greater than the default threshold value; and

An executing module 3 adapted for executing an interaction corresponding to the operation type according to the operation type.

Preferably, the determining module 2 can be further adapted for:

Presetting a matching relationship between the gesture and the operation type; and

Determining the operation type corresponding to the gesture according to determination of whether the downward acceleration of the gesture is greater than the default threshold value combined with the matching relationship between the gesture and the operation type.

Preferably, the determining module 2 can be further adapted for:

Determining the operation type corresponding to the gesture to be a normal type if the downward acceleration of the gesture is not greater than the default threshold value, wherein the normal type comprises: a normally sliding type and a clicking type; and

Determining the operation type corresponding to the gesture to be an accelerated type if the downward acceleration of the gesture is greater than the default threshold value.

Preferably, the executing module 3 can be further adapted for:

Executing the interaction according to a default interaction strategy when the operation type is the normally sliding type, wherein the default interaction strategy comprises: the displayed interface is progressively changed from the replying information full screen extension interface to the replying information full screen interface with the gesture; or alternatively, the displayed interface is changed from the replying information full screen interface to the replying information and recognition result interface with the gesture; or alternatively, the displayed interface is changed from the replying information and recognition result interface to the speech recognition interface with the gesture;

Triggering a button located on the top edge of the displayed interface such that the current interface is directly changed back to the speech recognition interface when the operation type is the clicking type under the replying information full screen extension interface or the replying information full screen interface; and

Changing the current interface back to the speech recognition interface directly, when the operation type is the accelerated type.

The device shown in FIG. 2 is able to execute the method disclosed in FIG. 1. The principle and the technical effect of the method and device can be referred to the embodiments of FIG. 1 and FIG. 2, and any related illustration is omitted hereafter.

The following provides an introduction of a specific application of the device in this embodiment. The following illustration for the specific application is exemplary, and the present disclosure is not limited thereto.

Application

Take the speech assistant as an example, in the idle interface of the speech assistant, the user is able to trigger a button or speak to activate the speech assistant from the idle state to the record state. The button is triggered from static state to dynamic state, and the recording volume is synchronized with the dynamic vibration effect of the button. After the record of the speech is finished, the speech assistant automatically changes from the record state to the recognition state, or the user can manually trigger the button to close the record state.

After the record of the speech is finished, the button in the dynamic state is moved downward to the bottom of the interface, and then drags up the replying information interface with white background from bottom of the interface. At this time, another dynamic effect of the button is to display the content of recorded speech of the user. A part of the interface above the button has black background and displays recognized literal content of the recorded speech, and a part of the interface beneath the button has white background and displays the replying information to the user's instruction; at this time, this displayed interface is the replying information and recognition result interface.

When the recognition of the user's instruction is finished by the speech assistant, the button is triggered to be back to the static state, and the button pull the replying information and recognition result interface to move upward. At this time, the font size of the content is reduced when the part of the interface having black background is reduced gradually. The triggered button moves upward until it arrives at a position where a distance between the bottom of the interface and the triggered button is equal to two fives of the height of the interface; that is, the height of the recognition result interface (the black background part) is equal to two fives of the height of the interface, and the height of the replying information interface (the white background part) is equal to three fives of the height of the interface.

As this time, the user drags the interface from the bottom to the top to display a replying information full screen interface. After the replying information full screen interface is displayed, the button triggering speech recognition is located on the top edge of the interface. Under the state of the replying information full screen interface, the user drags up to continuously extend the information downward. At this time, the displayed interface is the replying information full screen extension interface.

Under the replying information full screen extension interface, the user drags the interface to move downward by the gesture having normally sliding type, such that the interface is changed back to the replying information full screen interface from the replying information full screen extension interface. The top of the replying information is displayed on the top of the interface. After the interface is changed back to the replying information full screen interface, the user keeps dragging the interface, such that the recognition result is moved back to visible region. At this time, the interface is the replying information and recognition result interface, wherein the black background part in the interface displays the recognition result interface, and the white background part in the interface displays the replying information interface. When the user keeps dragging downward to the speech recognition state, the interface is changed back to the speech recognition interface. Meanwhile, when the interface is the replying information full screen interface or the replying information full screen extension interface, the button on the top edge of the interface can be directly triggered to change back to the speech recognition state.

When the displayed interface of the speech assistant is the replying information and recognition result interface, the replying information full screen interface or the replying information full screen extension interface, the user can move the gesture with a downward acceleration; that is, the user drags the interface by the gesture having the accelerated type. Thus, the interface is directly changed back to the speech recognition interface, and the speech assistant is back to the speech recognition state.

According to the embodiments of the present disclosure, a method for interaction with terminal and a device for the same are provided for solving some problems in the conventional technique that the user operation cost is increased when the current interface is changed to the recording interface from other interfaces. By the accelerated sliding effect generated by the interaction between the user and the screen of the mobile terminal, the relative displacement between the interface and the gesture can be determined such that different responses can be executed. The displayed interface can be directly returned to the speech recognition interface by simply operation with the user's gesture, and the operation steps is also reduced and become convenient. Since the steps for changing the interface back to the recording interface are simplified, it is favorable for reducing user operation cost so as to improve user experience.

### 3^{rd} Embodiment

Another embodiment of the application discloses a non-volatile computer storage medium storing a computer-executable instruction, and the computer-executable instruction is adapted for executing the method for interaction with terminal in any one of the embodiments.

### 4^{th} Embodiment

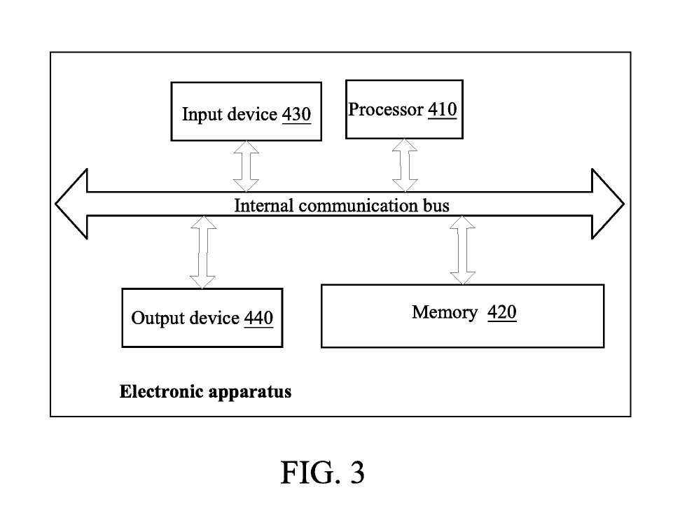

The present application further discloses an electronic apparatus for interaction with terminal. As shown in FIG. 3, the electronic apparatus includes:

One or more processors 410 and a memory 420, and the processor 410 is one in quantity in FIG. 3.

The electronic apparatus for displaying multi-path videos on the broadcast console can include: an input device 430 and an output device 440.

The processor 410, the memory 420, the input device 430 and the output device 440 can be connected to each other via a bus or other members for electrical connection. In FIG. 3, they are connected to each other via the bus in this embodiment.

The memory 420 is one kind of non-volatile computer-readable storage mediums applicable to store non-volatile software programs, non-volatile computer-executable programs and modules, such as the program instructions and the function modules disclosed in this application (the detecting module 1, the determining module 2 and the executing module 3 in FIG. 2). The processor 410 executes function applications and data processing of the server by running the non-volatile software programs, the non-volatile computer-executable programs and modules stored in the memory 420, and thereby the methods for displaying multi-path videos on the broadcast console in the aforementioned embodiments are achievable.

The memory 420 can include a program storage area and a data storage area, wherein the program storage area can store an operating system and at least one application program required for a function; the data storage area can store the data created according to the usage of the device for displaying multi-path videos on the broadcast console. Furthermore, the memory 32 can include a high speed random-access memory, and further include a non-volatile memory such as at least one disk storage member, at least one flash memory member and other non-volatile solid state storage member. In some embodiments, the memory 420 can have a remote connection with the processor 410, and such memory can be connected to the device for controlling data rate of motion video by a network. The aforementioned network includes, but not limited to, internet, intranet, local area network, mobile communication network and combination thereof.

The input device 430 can receive digital or character information, and generate a key signal input corresponding to the user setting and the function control of the device for controlling data rate of motion video. The output device 440 can include a displaying unit such as screen.

The one or more modules are stored in the memory 420. When the one or more modules are executed by one or more processor 410, the method for displaying multi-path videos on the broadcast console disclosed in any one of the embodiments is performed.

The method provided in the embodiments, the function of each functional module and the relationships among the functional modules are all executable by the electronic apparatus. Any deficiencies in the illustration can be referred to the embodiments of the present disclosure.

The electronic apparatus in the embodiments of the present application is presence in many forms, and the electronic apparatus includes, but not limited to:
(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.
(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.
(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.
(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.
(5) Other electronic apparatus having a data exchange function.

The aforementioned embodiments are described for the purpose of explanation. The element for explanation can be a physical element or not; that is, the element for explanation can be located on a specific position or distrusted among plural network units. Many modifications and variations are possible in view of part or all of the above teachings, to thereby enable others skilled in the art to best utilize the disclosure and various embodiments with various modifications in order to suit to the particular use contemplated.

By the above described embodiment, those skilled in the art can understand that the present disclosure may be implemented by the computer readable storage medium which may include volatile and non-volatile, removable and non-removable media may be made in any method or technology to achieve information storage. Information can be computer readable instructions, data structures, program modules or other data. Examples of computer readable storage medium include, but are not limited to phase change memory (the PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storage, magnetic tape cassette, magnetic disk storage or other magnetic tape storage mediums, or any other magnetic non-transmission medium, it may be used to store the information can be computing device access. Defined in accordance with this article, a computer-readable medium excluding non staging computer-readable media (transitory media), such as a modulated data signal and the carrier.

Although various embodiments of the present disclosure are described above with reference to figures, those skilled in the art would understand that the various embodiments of the present disclosure is made, may also departing from the present disclosure is not based on make a variety of improvements. Accordingly, the scope of the disclosure should be determined by the appended claims contents of the book claims.

What is claimed is:

1. A method for interaction with terminal, comprising:
determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished;
determining an operation type corresponding to the gesture, according to determination of whether the downward acceleration of the gesture is greater than the default threshold value; and
executing an interaction corresponding to the operation type, according to the operation type.

2. The method according to claim 1, wherein, before the determining the operation type corresponding to the gesture, the method further comprises:
presetting a matching relationship between the gesture and the operation type; and
determining the operation type corresponding to the gesture, according to determination of whether the downward acceleration of the gesture is greater than the default threshold value combined with the matching relationship between the gesture and the operation type.

3. The method according to claim 1, wherein, the determining the operation type corresponding to the gesture according to determination of whether the downward acceleration of the gesture is greater than the default threshold value further comprises:
determining the operation type corresponding to the gesture to be a normal type, if the downward acceleration of the gesture is not greater than the default threshold value, wherein the normal type comprises: a normally sliding type and a clicking type; and
determining the operation type corresponding to the gesture to be an accelerated type, if the downward acceleration of the gesture is greater than the default threshold value.

4. The method according to claim 3, wherein, the executing the interaction corresponding to the operation type according to the operation type further comprises:
executing the interaction according to a default interaction strategy, when the operation type is the normally sliding type, wherein the default interaction strategy comprises: the displayed interface is progressively changed from the replying information full screen extension interface to the replying information full screen interface with the gesture, or alternatively, the displayed interface is changed from the replying information full screen interface to the replying information and recognition result interface with the gesture, or alternatively, the displayed interface is changed from the replying information and recognition result interface to the speech recognition interface with the gesture;
triggering a button located on the top edge of the displayed interface such that current interface is directly changed back to the speech recognition interface, when the operation type is the clicking type under the replying information full screen extension interface or the replying information full screen interface; and
changing current interface back to the speech recognition interface directly, when the operation type is the accelerated type.

5. A non-volatile computer storage medium storing a computer-executable instruction, and the computer-executable instruction being for:
determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished;
determining an operation type corresponding to the gesture, according to determination of whether the downward acceleration of the gesture is greater than the default threshold value; and
executing an interaction corresponding to the operation type, according to the operation type.

6. An electronic apparatus, comprising:
at least one processor; and
a memory communicatively connected to the at least one processor, wherein the memory stores an instruction executable by the at least one processor, the at least one processor is for calling the instruction to execute a method comprising:
determining whether a downward acceleration of a gesture is greater than a default threshold value when the gesture is detected under state of a displayed interface, wherein the displayed interface comprises: a replying information and recognition result interface, a replying information full screen interface, or a replying information full screen extension interface after record of speech in a speech recognition interface is detected to be finished;
determining an operation type corresponding to the gesture, according to determination of whether the downward acceleration of the gesture is greater than the default threshold value; and
executing an interaction corresponding to the operation type, according to the operation type.

7. The non-volatile computer storage medium according to claim 5, wherein, before the determining the operation type corresponding to the gesture, the computer-executable instruction is further for:
presetting a matching relationship between the gesture and the operation type; and
determining the operation type corresponding to the gesture, according to determination of whether the downward acceleration of the gesture is greater than the default threshold value combined with the matching relationship between the gesture and the operation type.

8. The non-volatile computer storage medium according to claim 5, wherein, the determining the operation type corresponding to the gesture according to determination of whether the downward acceleration of the gesture is greater than the default threshold value further comprises:
determining the operation type corresponding to the gesture to be a normal type, if the downward acceleration of the gesture is not greater than the default threshold value, wherein the normal type comprises: a normally sliding type and a clicking type; and
determining the operation type corresponding to the gesture to be an accelerated type, if the downward acceleration of the gesture is greater than the default threshold value.

9. The non-volatile computer storage medium according to claim 8, wherein, the interaction corresponding to the operation type according to the operation type further comprises:
executing the interaction according to a default interaction strategy, when the operation type is the normally sliding type, wherein the default interaction strategy comprises: the displayed interface is progressively changed from the replying information full screen extension interface to the replying information full screen interface with the gesture, or alternatively, the displayed interface is changed from the replying information full screen interface to the replying information and recognition result interface with the gesture, or alternatively, the displayed interface is changed from the replying information and recognition result interface to the speech recognition interface with the gesture;
triggering a button located on the top edge of the displayed interface such that current interface is directly changed back to the speech recognition interface, when the operation type is the clicking type under the replying information full screen extension interface or the replying information full screen interface; and
changing current interface back to the speech recognition interface directly, when the operation type is the accelerated type.

10. The electronic apparatus according to claim 6, wherein, before the determining the operation type corresponding to the gesture, the instruction is called to execute the method further comprising:
presetting a matching relationship between the gesture and the operation type; and
determining the operation type corresponding to the gesture, according to determination of whether the downward acceleration of the gesture is greater than the default threshold value combined with the matching relationship between the gesture and the operation type.

11. The electronic apparatus according to claim 6, wherein, the determining the operation type corresponding to the gesture according to determination of whether the downward acceleration of the gesture is greater than the default threshold value further comprises:
determining the operation type corresponding to the gesture to be a normal type, if the downward acceleration of the gesture is not greater than the default threshold value, wherein the normal type comprises: a normally sliding type and a clicking type; and
determining the operation type corresponding to the gesture to be an accelerated type, if the downward acceleration of the gesture is greater than the default threshold value.

12. The electronic apparatus according to claim 11, wherein, the interaction corresponding to the operation type according to the operation type further comprises:
executing the interaction according to a default interaction strategy, when the operation type is the normally sliding type, wherein the default interaction strategy comprises that: the displayed interface is changed from the replying information full screen extension interface to the replying information full screen interface with the gesture, or alternatively, the displayed interface is changed from the replying information full screen interface to the replying information and recognition result interface with the gesture, or alternatively, the displayed interface is changed from the replying information and recognition result interface to the speech recognition interface with the gesture;
triggering a button located on the top edge of the displayed interface such that current interface is directly changed back to the speech recognition interface, when the operation type is the clicking type under the replying information full screen extension interface or the replying information full screen interface; and
changing current interface back to the speech recognition interface directly, when the operation type is the accelerated type.
